(19) United States
(12) Patent Application Publication
(10) Pub. No.: US 2016/0078678 A1
(43) Pub. Date: Mar. 17, 2016

(54) AUGMENTED REALITY METHOD AND APPARATUS FOR ASSISTING AN OPERATOR TO PERFORM A TASK ON A MOVING OBJECT

(71) Applicant: CENTRE DE RECHERCHE INDUSTRIELLE DU QUEBEC, Quebec (CA)

(72) Inventors: Denis Hotte, Quebec (CA); Nicholas Drolet, Saint-Nicolas (CA); Alain Martel, Quebec (CA); Richard Gagnon, Quebec (CA); Claude Lejeune, Quebec (CA)

(73) Assignee: CENTRE DE RECHERCHE INDUSTRIELLE DU QUEBEC, Quebec (CA)

(21) Appl. No.: 14/485,051

(22) Filed: Sep. 12, 2014

(51) Int. Cl. G06T 19/00; G06Q 10/06

(52) U.S. Cl. CPC G06T 19/006; G06Q 10/06311; G06T 2219/024

(57) ABSTRACT

Augmented reality-based method, apparatus and system for assisting an operator to perform a task on a moving object according to at least one characteristic of the object, uses projection of light onto the object according to object tracking task instruction data as it moves through the working zone to provide a visual instruction for the operator about the task to perform on the object.

### TECHNICAL FIELD

The present invention relates to the field of augmented reality industrial applications, and more particularly to augmented reality methods and apparatus for assisting an operator to perform tasks on moving objects.

### BACKGROUND OF THE ART

Numerous systems have been proposed to perform real-time characterization and selective physical separation of moving objects such as recyclable materials transported on a conveyer, into multiple categories, depending on the sensed characteristics of the materials.

In Published U.S. Patent application No. 2013/141115 A1, there is disclosed an automatic process and installation for inspecting and/or sorting articles belonging to at least two different categories, and made to advance approximately in a single layer, for example on a conveyor belt or a similar transport support. The process includes subjecting the advancing flow of articles to at least two different types of contactless analysis by radiation, respectively a surface analysis and a volume analysis, whose results are used in a combined manner for each article to perform a discrimination among these articles and/or an evaluation of at least one characteristic of the latter. The surface analysis is performed to determine the physical and/or chemical composition of the outer layer of an article exposed to the radiation used. The surface analysis may use infrared radiation for optical/thermographic analysis, or may use X-ray fluorescence or laser-induced plasma spectroscopy for analysis of atomic composition. The volume analysis is performed to determine the equivalent thickness of material of the same article, by the use of microwaves/UHF waves or transmission X-rays. The moisture level of articles made of fibrous material may be determined from the combined results furnished by the surface and volume analysis processes. The data collected by the different analyses are then pooled in a data processing unit and then analyzed to determine the characteristics of each article. An ejection system can be provided to separate the articles into two or more categories. Another automatic system for inspecting and sorting non-metallic articles such as cardboard-paper, plastics (packages, films, bags, ground waste of electronic or automobile origin) or biological wastes, based on thermographic analysis is described in U.S. Pat. No. 8,083,066, which system is also provided with a separation means using a nozzle bar actuated to eject the selected articles through air jets. Another automatic sorting system based on hyperspectral imaging with broad spectrum lighting means employing a mixture of electromagnetic radiation in the visible range and in the infrared range, is disclosed in U.S. Pat. No. 7,113,272, which system also makes use of a separation station provided with ejection means in the form of nozzles in a row activated by means of a control module.

Although known radiation-based, contactless technologies have proved to be highly effective for evaluation of articles characteristics to provide accurate discrimination among these articles, known automatic ejection means such as air nozzle bars have not proved to be efficient in cases such as recyclable materials sorting applications, where the articles to be physically sorted are in large quantity, randomly distributed on a conveyer travelling at relatively high velocity. In such cases where automatic sorting equipment cannot be efficiently used, manual sorting by operators trained to inspect, discriminate and physically sort the articles is involved, which tasks are very demanding and tedious, while providing limited sorting yields. Although contactless inspection technologies could be combined with more efficient separation means involving robotics to provide automatic sorting equipment capable of higher sorting yields, the integration of sophisticated robotic devices significantly increases the cost and complexity of the sorting system, which could not be managed by many sorting plants.

### SUMMARY

It is a main object of the present invention to provide augmented reality-based method, apparatus and system for assisting an operator to perform a task on a moving object according to at least one characteristic of the object.

According to one broad aspect of the invention, there is provided an augmented reality method for assisting an operator to perform a task within a working zone on an object moving along a path intersecting the working zone and according to at least one characteristic of said object, said method being for use with a sensor unit configured to generate data indicative of the object characteristic at a detecting position upstream the working zone. The method comprises the steps of: i) generating task instruction data according to the characteristic indicative data; ii) estimating successive positions of the object as it moves toward and through the working zone to generate object position tracking data; iii) processing the task instruction data and the object position tracking data to generate object tracking task instruction data; and iv) projecting light according to the object tracking task instruction data onto the object as it moves through the working zone to provide a visual instruction for the operator about the task to perform on the object.

In one embodiment, the task instruction data are indicative of one of plurality of object sorting instructions for the operator.

In one embodiment, the object is moving along a substantially linear path under action of a transport means in a transport direction, the sensor unit is further configured to generate data indicative of a transverse position coordinate of the object relative to the transport direction, and the estimating step ii) includes: a) measuring displacement of the transport means to derive successive object longitudinal position coordinates relative to the transport direction; and b) combining the successive object longitudinal position coordinates with the object transverse position coordinate to estimate the successive positions.

In one embodiment, the object tracking task instruction data are in the form of successive bidimensional images of an indication of the operator task instruction.

According to another broad aspect of the invention, there is provided an augmented reality method for assisting an operator to perform a task within a working field on an object moving along a path intersecting the working zone and according to at least one characteristic of the object. The method comprises the steps of: i) detecting the object characteristic at a detecting position upstream the working zone to generate characteristic indicative data; ii) generating task instruction data according to the characteristic indicative data; iii) estimating successive positions of the object as it moves toward and through the working zone to generate object position tracking data; iv) processing the task instruction data and the object position tracking data to generate object tracking task instruction data; and v) projecting light according to the object tracking task instruction data onto the object as it moves through the working zone to provide a visual instruction for the operator about the task to perform on the object.

In one embodiment, the task instruction data are indicative of one of a plurality of object sorting instructions for the operator.

In one embodiment, the object is moving along a substantially linear path under action of a transport means in a transport direction, the sensor unit is further configured to generate data indicative of a transverse position coordinate of the object relative to the transport direction, and the estimating step iii) includes: a) measuring a transverse position coordinate of the object relative to the transport direction; b) measuring displacement of the transport means to derive successive object longitudinal position coordinates relative to the transport direction; and c) combining the successive object longitudinal position coordinates with the object transverse position coordinate to estimate the successive positions.

In one embodiment, the object tracking task instruction data are in the form of successive bidimensional images of an indication of the operator task instruction.

According to another broad aspect of the invention, there is provided an augmented reality apparatus for assisting an operator to perform a task within a working zone on an object moving along a substantially linear path intersecting the working zone under action of a transport means in a transport direction and according to at least one characteristic of the object, the apparatus being for use with a sensor unit configured to generate data indicative of said object characteristic at a detecting position upstream the working zone, the sensor unit being further configured to generate data indicative of a transverse position coordinate of said object relative to the transport direction. The apparatus comprises means for measuring displacement of said transport means to derive successive object longitudinal position coordinates relative to said transport direction and data processor means programmed for: generating task instruction data according to the characteristic indicative data; estimating from the successive object longitudinal position coordinates and the object transverse position coordinate successive positions of the object as it moves toward and through the working zone, to generate object position tracking data; and processing the task instruction data and the object position tracking data to generate object tracking task instruction data. The apparatus further comprises a projector for directing light according to the object tracking task instruction data onto the object as it moves through the working zone to provide a visual instruction for the operator about the task to perform on the object.

In one embodiment, the task instruction data are indicative of one of a plurality of object sorting instructions for the operator.

In one embodiment, the object tracking task instruction data are in the form of successive bidimensional images of an indication of the operator task instruction.

According to another broad aspect of the invention, there is provided an augmented reality system for assisting an operator to perform a task within a working zone on an object moving along a substantially linear path intersecting the working zone under action of a transport means in a transport direction and according to at least one characteristic of the object. The system comprises: a sensor unit configured for detecting the object characteristic at a detecting position upstream the working zone to generate characteristic indicative data, the sensor unit being further configured to generate data indicative of a transverse position coordinate of said object relative to the transport direction, means for measuring displacement of the transport means to derive successive object longitudinal position coordinates relative to the transport direction, and data processor means programmed for: generating task instruction data according to the characteristic indicative data; estimating from the successive object longitudinal position coordinates and said object transverse position coordinate successive positions of the object as it moves toward and through the working zone, to generate object position tracking data; and processing the task instruction data and said object position tracking data to generate object tracking task instruction data. The system further comprises a projector for directing light according to the object tracking task instruction data onto the object as it moves through the working zone to provide a visual instruction for the operator about the task to perform on the object.

In one embodiment, the task instruction data are indicative of one of a plurality of object sorting instructions for the operator.

In one embodiment, the object tracking task instruction data are in the form of successive bidimensional images of an indication of the operator task instruction.

### BRIEF DESCRIPTION OF THE DRAWINGS

Having described above the general nature of the invention, some example embodiments of the present invention are described below by way of illustration with reference to the accompanying drawings in which:

FIG. 1 is a schematic side view of an augmented reality based system for assisting an operator to perform a sorting task according to one particular embodiment of the present invention;

FIG. 2 is a schematic plan view of the conveyer surface provided on the system of FIG. 1, showing detecting and working zones respectively at sensing and working positions along the conveyer;

FIG. 3 is a hardware block diagram showing data communication between main components of the system of FIG. 1.

FIG. 4 is a flowchart showing the steps as performed by the sensor unit, the computer, and the projector provided on the system of FIG. 1, according to one particular embodiment of the proposed operator assisting method;

FIG. 5 is a diagram representing a functional architecture of the computer software programmed in the computer provided on the system of FIG. 1 and capable of performing some of the method steps of FIG. 4; and

FIG. 6 is a diagram depicting in perspective an augmented reality based system for assisting more than one operator to perform sorting tasks according to another embodiment of the present invention.

### DETAILED DESCRIPTION

According to example embodiments of the invention, an augmented reality-based method, apparatus and system for assisting an operator to perform a task on moving objects according to characteristics thereof will now be described in the context of an application where the operator is assisted to perform real-time sorting of recyclable materials transported on a conveyer, according to the nature of the materials involved. It is to be understood that the method, apparatus and system according to the present invention may be employed for assisting an operator to perform different tasks on objects of various types and according to diverse characteristics in other industrial contexts. For example, the invention may be used for sorting various kinds of objects, such as foods (eggs, pieces of meat, fruits, vegetables) according to detected characteristics such as size, coloration, surface defects and moisture, or for sorting metallic objects according to their response to electromagnetic radiation, such as X-rays or microwaves. Being not limited to handling tasks, the invention may also be used for diverse operations involved in product manufacturing such as selective part painting or assembling, and for quality control of manufactured products.

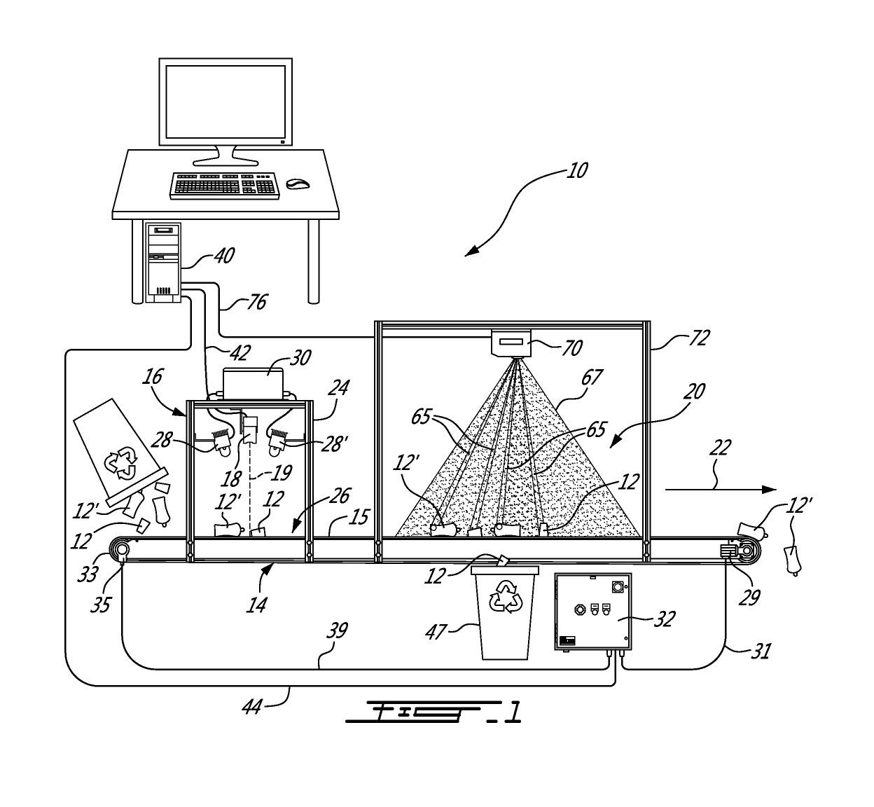

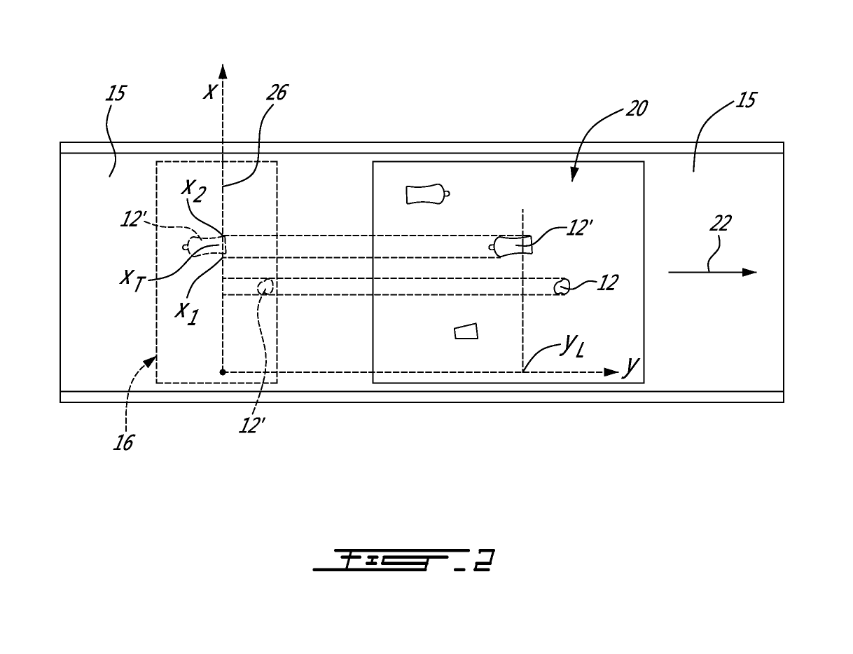

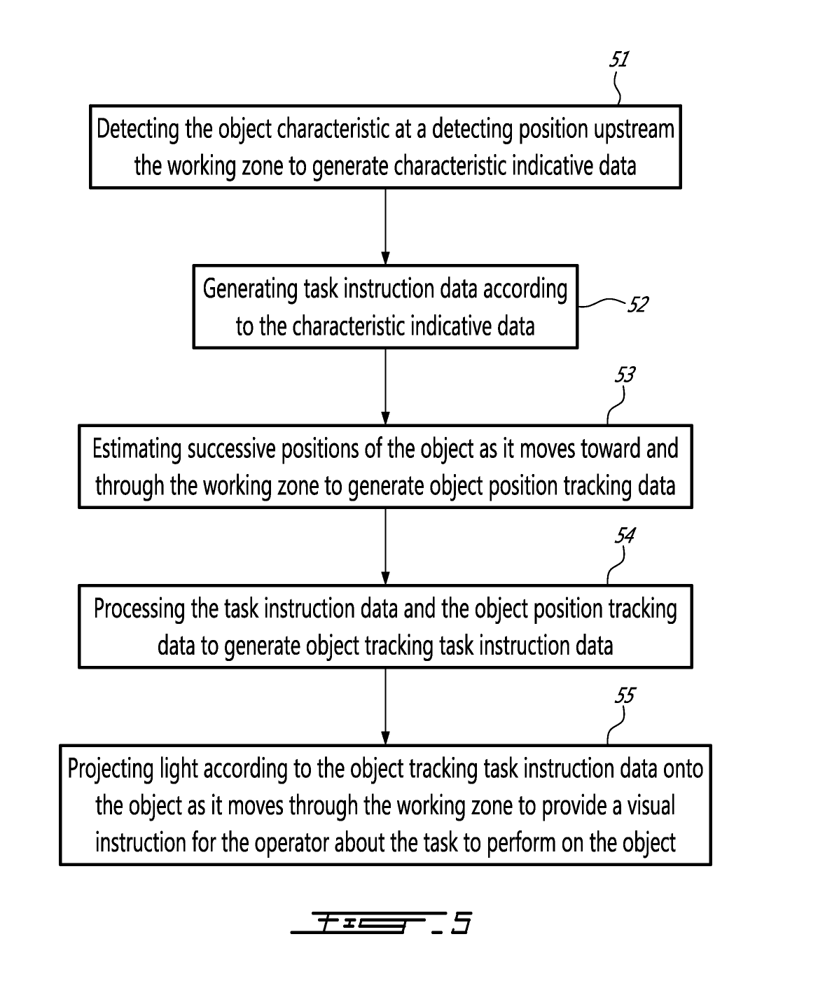

Referring now to FIG. 1, an augmented reality system generally designated at 10, includes instrumentation as well as computer hardware and software providing the capability of assisting an operator to perform a task within a working zone on a moving object according to at least on characteristic thereof, such as a sorting task performed on a selected one of recyclable articles 12, 12′ transported on a conveyer 14, depending on a detection of the specific material from which it is constituted. The conveyer 14 can be a roller belt conveyer having its driving motor 29 linked through line 31 to a control and power supply unit 32. It can be appreciated that in the example embodiment of FIG. 1, the articles 12, 12′ are transported along a substantially linear path intersecting the operator working zone 20 under action of the conveyer 14 in a transport direction indicated by arrow 22. As for the example shown in FIG. 1, articles designated at 12 can be fiber-based articles such as recyclable pieces of wood, paper or cardboard, and articles designated at 12′ can be made of plastic materials of various types, to be sorted for purposes of materials recovery. The material characteristic to be detected can be selected depending upon the nature of the material and predetermined sorting criteria. Candidate characteristics are: dimensions, shape, color, composition, moisture, internal components and contaminants content. The augmented reality system 10 is provided with an appropriate sensor unit 16 capable of specifically detecting at least one selected characteristic, which sensor unit may include a plurality of sensors, each being adapted to detect a distinct characteristic of the inspected objects. It can be appreciated from FIG. 1 that the sensor unit 16 is configured for detecting the object characteristic at a detecting position upstream the operator working zone 20, to generate characteristic indicative data, which correspond to method step 51 on the flowchart of FIG. 4, which will be explained below in more detail. In the context of the present example application, due to the fact that many recyclable materials such as PET and HDPE/LDPE plastics exhibit distinct reflection signatures in the near-infrared spectrum, the sensor unit 16 can include as a main sensor 18, a hyperspectral camera operating in the near-infrared spectrum, such as model Zephir™ from Photon ETC (Montreal, Canada), model SWIR from Specim (Oulu, Finland) or any other appropriate hyperspectral camera available on the marketplace. The sensor unit 16 is also provided with appropriate lighting devices 28, 28′ connected to a power supply unit 30 and capable of generating and directing light, characterized by an appropriate spectral range including near-infrared wavelengths, toward the detecting area 26 on the conveyer surface 15 as shown in FIG. 1 in view of FIG. 2. In another embodiment, a spectrometer also operating in a near-infrared spectrum can be used. A spectrometer as disclosed in U.S. Pat. No. 7,113,272, the content of which being incorporated by reference herein, or any other appropriate spectrometer available on the marketplace, may be used as main sensor 18. From reference spectral measurements obtained with samples of the various materials to discriminate, reference signatures can be obtained and used to calibrate the sensor 18, which is then capable of generating characteristic indicative data, to discriminate between the materials from which the inspected articles are constituted. In other embodiments, so as to provide enhanced discrimination capability between specific materials involved, the main sensor 18 can be used in combination with a color digital camera and/or a visible range spectrometer (not shown) as part of the sensor unit 16. In another embodiment, a hyperspectral camera operating in the visible range may be used in addition to the main sensor 18, such as model VIS from Specim (Oulu, Finland). In an embodiment, a hyperspectral camera operating in the near-infrared and visible ranges can be used as the main sensor, such as model VNIR also from Specim (Oulu, Finland). In another embodiment, a complete sensor unit integrating a spectrometer and color sensor may be used, such as model Mistral™ from Pellenc ST (Pertuis, France).

In the embodiment shown in FIG. 1, the sensor 18 is mounted above the object conveying surface 15 on a frame 24 provided on the sensor unit 16 and secured to the conveyer sides, so that sensor 18 has its sensing field 19 directed toward the object conveying surface 15 at the detecting position, defining a linear detecting zone 26 extending along an axis X transverse to a longitudinal axis Y of the conveyer parallel to the transport direction 22 as shown in FIG. 2. The sensor unit 18 is provided with a casing (not shown) having appropriate opposed input and output openings allowing articles 12,12′ to pass through the sensing field 19, while protecting and isolating the sensor components from the plant environment.

In another embodiment, a thermal sensor such as disclosed in U.S. Pat. No. 8,083,066, the content of which being incorporated by reference herein, can be also used to discriminate between plastic materials through thermographic analysis.

In other embodiments, a color digital camera, visible range spectrometer, or laser-based profilometer can be used as main sensor 18 to detect color-based or dimensional characteristics such as surface defects, texture or size. For example, a color linear camera such as model Xiimus™ from TVI Vision Oy (Helsinki, Finland) may be used. In other embodiments, sensors based on X-rays, microwaves, ultrasound, or LIBS (Laser Induced Breakdown Spectroscopy), may be used as main or complementary sensors to provide other material discrimination capability (e.g. metal).

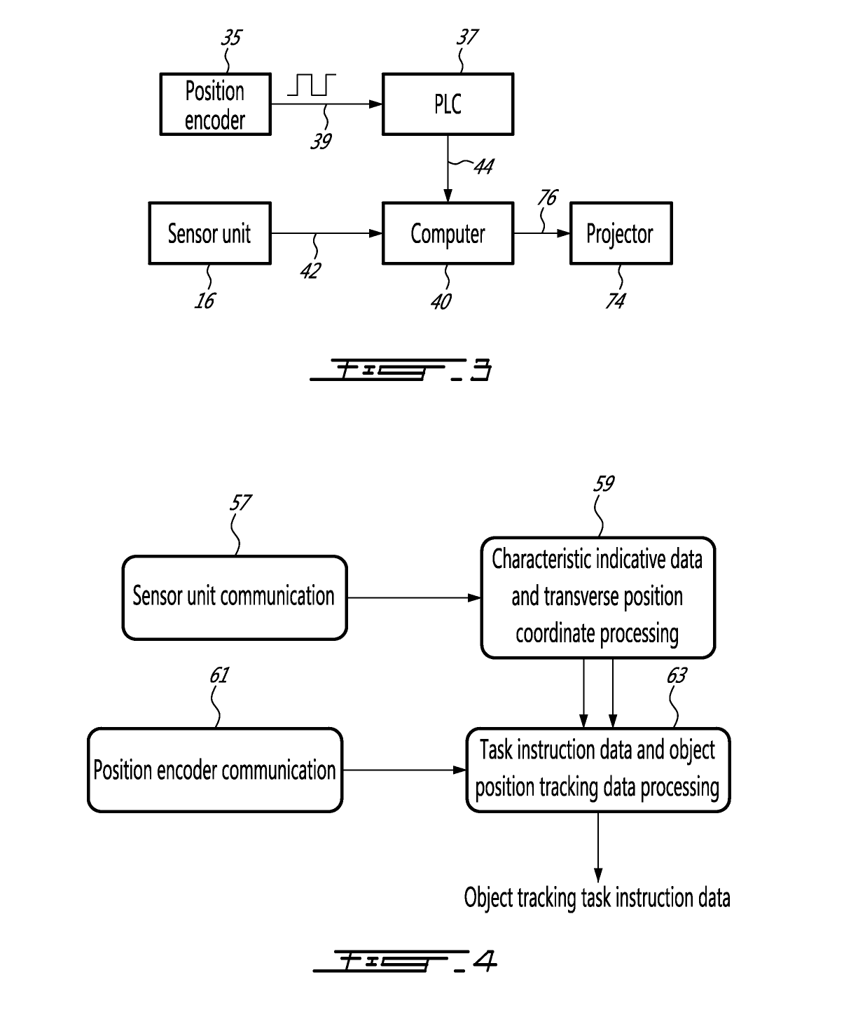

The sensor unit 16 is further configured to generate data indicative of a transverse position coordinate of each article 12, 12′ relative to the transport direction 22, which transverse position coordinate is expressed with reference to axis X in FIG. 2 centered at the detecting position with respect to sensor unit 16 shown in truncated lines. For example, the transverse position coordinate X_{T} for an article 12′ (shown in dotted lines) traversing the detecting zone 26 prior to reach the working zone 20 (article 12′ shown in solid line) can be derived by the sensor 18 through a detection of the maximum outer edges the article 12′ to obtain X₁ and X₂ in the example shown, followed by calculation of mean value. Furthermore, the system 10 further includes means for measuring displacement of the conveyer surface 15, to derive successive object longitudinal position coordinates relative to the transport direction. In the embodiment shown in FIG. 1, and further in view of FIG. 3, the displacement measuring means include a rotary position encoder 35 operationally coupled to a front roller 33 of the conveyer 14, for sending a pulse sequence signal via data line 39 to a proper interface 37, such as a programmable Logic Controller (PLC), which converts pulse sequence signal into a computer-compatible data signal according to an appropriate format (e.g. USB), which signal represents successive object longitudinal position coordinates along axis Y which is parallel to the transport direction 22, as shown in FIG. 2. A rotary position encoder such as model 844B from Allen Bradley (Milwaukee, Wis.), or any appropriate displacement or velocity sensor, may be used. A PLC such as model Micrologix 100 also from Allen Bradley, or any appropriate converting interface, may be used. Conveniently, the PLC interface 37 may be integrated into the control and supply unit 32 as shown in FIG. 1.

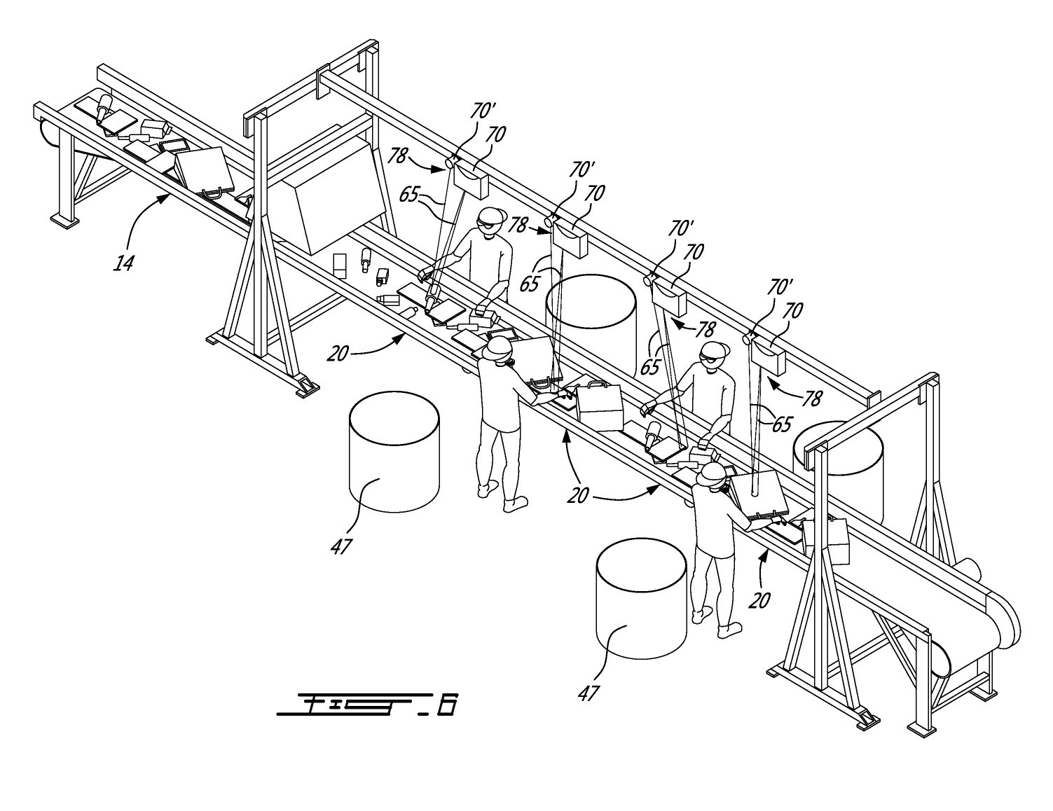

The system 10, further includes data processor means that can be in the form of a computer 40 provided with suitable memory and programmed to perform the data processing method steps presented in the flowchart of FIG. 5, making use of the software functional architecture shown in FIG. 5. Referring to FIG. 5, following the detecting step 51 resulting in characteristic indicative data, the computer is programmed for generating at step 52 task instruction data according to the characteristic indicative data received from the sensor unit 16 through data line 42 as better shown in FIG. 3. The computer 40 also receives from the sensor unit 16 the transverse position coordinate indicative signal, whose value is assumed to be substantially constant as the object is moved under action of the conveyer 14 in the transport direction 22. For so doing, as shown in FIG. 4, the functional architecture of the computer software includes a sensor unit communication module 57, which collects characteristic indicative data and transverse position coordinate as they are received from the sensor unit, and transfer these data to a first processing module 59 at request therefrom, which generates the task instruction data which are fed to a second processing module 63, which also receives the transverse position coordinate as relayed by the first processing module 59. Turning back to FIG. 3, through data line 39, PLC interface 37 and data line 44, the computer 40 further receives the successive object longitudinal position coordinates as generated by the position encoder 35. For so doing, as shown in FIG. 5, the software functional architecture further includes a position sensor communication module 61, which collects the successive object longitudinal position coordinates as they are received from the position encoder unit, and transfer these data to the second processing module 63 at request therefrom. Turning back to FIG. 5 in view of FIG. 2, the computer 40 is also programmed for estimating at step 53, by combining the successive object longitudinal position coordinates along Y axis and object transverse position coordinate along X axis, successive positions of the object as it moves toward and through the working zone 20, to generate object position tracking data, which estimating step 53 is performed by the second processing module 63 shown in FIG. 4. In the example shown in FIG. 2, the object position tracking data correspond to position coordinates X_{T}, Y_{L} for the article 12′ as located within the working area 20 at a specific time. Turning back to FIG. 5, he computer is further programmed for processing at step 54 the task instruction data and the object position tracking data to generate object tracking task instruction data, which step is also performed by the second processing module shown in FIG. 4.

Turning back to FIG. 1 in view of FIG. 3, the system 10 further includes a projector 70 conveniently mounted above the operator working zone 20 on a frame 72 secured to the conveyer sides, so that the projector has its projecting field directed toward the object conveying surface 15 and through the operator working zone 20. Any appropriate monochrome or color light projector may be used, such as video color projector model HD25-LC from Optoma (Fremont, Calif.). As shown in FIGS. 1 and 3, the projector 74 is linked to the computer 40 through data line 76 to receive the object tracking task instruction data. Corresponding to the final method step 55 shown in the flowchart of FIG. 5, the projector 70 is operated for directing light according to the object tracking task instruction data onto the object as it moves through the working zone 20 to provide a visual instruction for the operator about the task to perform on the object. In the example shown in FIG. 1, the light is projected in the form of a lighting image delimited by a tridimensional fan-shaped projection 67, producing light beams 65, each pointing a target article 12, 12′. For example, the operator may be instructed to pick up fiber-based articles 12 and throw them in a particular bin 47 adjacent the operator working zone, thus allowing the plastic-based articles 12′ to reach the conveyer output.

In an embodiment, a laser projector capable of directing one or more steerable laser beams each providing a specific visual indication corresponding to an instruction to the operator can be used, such as model LP-CUBE™ from Z-laser (Freiburg, Germany). The use of a laser projector rather than or in combination with a video projector can be advantageous for applications where ambient light could interfere with video image projections.

In the example embodiment shown in FIG. 1, the task instruction data are indicative of one of plurality of object sorting instructions for the operator.

In one embodiment, the tracking task instruction data can be in the form of successive bidimensional images of an indication of the operator task instruction. For so doing, the second processor module 63 shown in FIG. 4 may acts as an image generator which creates a succession of images in which the indication intended for each target object is disposed according to transverse and longitudinal coordinates such that individual image portion corresponding to the indication is projected onto the corresponding target object. For each next image that is generated, each indication is displaced longitudinally based on the successive positions measured on the conveyer which corresponding to the object movement. Typically, a frame rate from 30 to 60 FPS can be sufficient to obtain an appropriate tracking of the object moving at a typical conveyer speed. The indication intended to the operator can take many forms, such as a light presence/absence indication, a light intensity indication, a pulsed light indication, a light pattern indication, a symbolic indication, a textual indication, a color indication, or any combination thereof.

In another embodiment, an augmented reality based system for assisting more than one operator to perform sequential sorting tasks as shown in FIG. 6, involves a plurality of working zones 20 associated with a plurality of projecting units 78 each provided with one or more projectors. For example, a projector 70 can be of a video type while a projector 70′ can be of a laser type, to provide higher flexibility of indications for the operators. The computer of the system may be programmed so that each projecting unit 78 provides visual instructions for the operator to which the working zone is assigned about one or more sorting tasks directed to types of articles specifically assigned to each operator. For example, beams of light 65 presenting distinct colors and/or indicative symbols can be used to instruct the operators about the tasks to perform on pointed articles, for example: spreading to a single layer on the conveyer 14; throw throwing in a particular bin 47 adjacent the operator working zone; leaving on the conveyer 14, etc.

It should be noted that the present invention is not limited to any particular computer, database or processor for performing the data processing tasks of the invention. The term “computer”, as that term is used herein, is intended to denote any machine capable of performing the calculations, or computations, necessary to perform the processing tasks of the invention.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

We claim:

1. An augmented reality method for assisting an operator to perform a task within a working zone on an object moving along a path intersecting the working zone and according to at least one characteristic of said object, said method being for use with a sensor unit configured to generate data indicative of said object characteristic at a detecting position upstream said working zone, said method comprising the steps of:
i) generating task instruction data according to said characteristic indicative data;
ii) estimating successive positions of said object as it moves toward and through the working zone to generate object position tracking data;
iii) processing said task instruction data and said object position tracking data to generate object tracking task instruction data; and
iv) projecting light according to said object tracking task instruction data onto said object as it moves through the working zone to provide a visual instruction for the operator about the task to perform on the object.

2. The method according to claim 1, wherein said task instruction data are indicative of one of a plurality of object sorting instructions for the operator.

3. The method according to claim 1, wherein said object is moving along a substantially linear path under action of a transport means in a transport direction and wherein said sensor unit is further configured to generate data indicative of a transverse position coordinate of said object relative to the transport direction, said estimating step ii) includes:
a) measuring displacement of said transport means to derive successive object longitudinal position coordinates relative to said transport direction; and
b) combining said successive object longitudinal position coordinates with said object transverse position coordinate to estimate said successive positions.

4. The method according to claim 1, wherein said object tracking task instruction data are in the form of successive bidimensional images of an indication of said operator task instruction.

5. The method according to claim 4, wherein said indication is selected from the group consisting of a light presence/absence indication, a pulsed light indication, a light intensity indication, a light pattern indication, a symbolic indication, a textual indication, a color indication, or any combination thereof.

6. An augmented reality method for assisting an operator to perform a task within a working field on an object moving along a path intersecting the working zone and according to at least one characteristic of said object, said method comprising the steps of:
i) detecting said object characteristic at a detecting position upstream said working zone to generate characteristic indicative data;
ii) generating task instruction data according to said characteristic indicative data;
iii) estimating successive positions of said object as it moves toward and through the working zone to generate object position tracking data;
iv) processing said task instruction data and said object position tracking data to generate object tracking task instruction data; and
v) projecting light according to said object tracking task instruction data onto said object as it moves through the working zone to provide a visual instruction for the operator about the task to perform on the object.

7. The method according to claim 6, wherein said task instruction data are indicative of one of a plurality of object sorting instructions for the operator.

8. The method according to claim 6, wherein said object is moving along a substantially linear path under action of a transport means in a transport direction and wherein said sensor unit is further configured to generate data indicative of a transverse position coordinate of said object relative to the transport direction, said estimating step iii) includes:
a) measuring a transverse position coordinate of said object relative to the transport direction;
b) measuring displacement of said transport means to derive successive object longitudinal position coordinates relative to said transport direction; and
c) combining said successive object longitudinal position coordinates with said object transverse position coordinate to estimate said successive positions.

9. The method according to claim 6, wherein said object tracking task instruction data are in the form of successive bidimensional images of an indication of said operator task instruction.

10. The method according to claim 9, wherein said indication is selected from the group consisting of a light presence/absence indication, a pulsed light indication, a light intensity indication, a light pattern indication, a symbolic indication, a textual indication, a color indication, or any combination thereof.

11. An augmented reality apparatus for assisting an operator to perform a task within a working zone on an object moving along a substantially linear path intersecting the working zone under action of a transport means in a transport direction and according to at least one characteristic of said object, said apparatus being for use with a sensor unit configured to generate data indicative of said object characteristic at a detecting position upstream said working zone, said sensor unit being further configured to generate data indicative of a transverse position coordinate of said object relative to the transport direction, said apparatus comprising:
means for measuring displacement of said transport means to derive successive object longitudinal position coordinates relative to said transport direction;
data processor means programmed for:
generating task instruction data according to said characteristic indicative data;
estimating from said successive object longitudinal position coordinates and said object transverse position coordinate successive positions of said object as it moves toward and through the working zone, to generate object position tracking data; and
processing said task instruction data and said object position tracking data to generate object tracking task instruction data; and
a projector for directing light according to said object tracking task instruction data onto said object as it moves through the working zone to provide a visual instruction for the operator about the task to perform on the object.

12. The apparatus according to claim 11, wherein said task instruction data are indicative of one of a plurality of object sorting instructions for the operator.

13. The apparatus according to claim 11, wherein said object tracking task instruction data are in the form of successive bidimensional images of an indication of said operator task instruction.

14. The method according to claim 13, wherein said indication is selected from the group consisting of a light presence/absence indication, a pulsed light indication, a light intensity indication, a light pattern indication, a symbolic indication, a textual indication, a color indication, or any combination thereof.

15. An augmented reality system for assisting an operator to perform a task within a working zone on an object moving along a substantially linear path intersecting the working zone under action of a transport means in a transport direction and according to at least one characteristic of said object, said system comprising:
a sensor unit configured for detecting said object characteristic at a detecting position upstream said working zone to generate characteristic indicative data, said sensor unit being further configured to generate data indicative of a transverse position coordinate of said object relative to the transport direction;
means for measuring displacement of said transport means to derive successive object longitudinal position coordinates relative to said transport direction;
data processor means programmed for:
generating task instruction data according to said characteristic indicative data;
estimating from said successive object longitudinal position coordinates and said object transverse position coordinate successive positions of said object as it moves toward and through the working zone, to generate object position tracking data; and
processing said task instruction data and said object position tracking data to generate object tracking task instruction data; and
a projector for directing light according to said object tracking task instruction data onto said object as it moves through the working zone to provide a visual instruction for the operator about the task to perform on the object.

16. The system according to claim 15, wherein said task instruction data are indicative of one of a plurality of object sorting instructions for the operator.

17. The system according to claim 15, wherein said object tracking task instruction data are in the form of successive bidimensional images of an indication of said operator task instruction.

18. The system according to claim 17, wherein said indication is selected from the group consisting of a light presence/absence indication, a pulsed light indication, a light intensity indication, a light pattern indication, a symbolic indication, a textual indication, a color indication, or any combination thereof.
